(19) United States
(12) Patent Application Publication
(10) Pub. No.: US 2013/0132290 A1
(43) Pub. Date: May 23, 2013

(54) Marketing and Sales Systems and Methods

(71) Applicant: Arrian C. Binnings, San Francisco, CA (US)

(72) Inventor: Arrian C. Binnings, San Francisco, CA (US)

(73) Assignee: Arrian C. Binnings, San Francisco, CA (US)

(21) Appl. No.: 13/681,375

(22) Filed: Nov. 19, 2012

Related U.S. Application Data
(60) Provisional application No. 61/561,238, filed on Nov. 17, 2011.

(51) Int. Cl. G06Q 50/16

(52) U.S. Cl. CPC G06Q 50/16
USPC 705/313

(57) ABSTRACT

Methods and systems for predicting the sales price of a property includes: (a) locating a property; (b) gathering estimates for a final sales price of the property; and (c) generating a final estimated sales price. Other embodiments are also disclosed herein.

### RELATED APPLICATION(S)

The present application claims priority from U.S. Provisional Patent Application No. 61/561,238, entitled “Marketing and Sales Systems and Methods,” filed on Nov. 17, 2011, which is incorporated by reference in its entirety.

### FIELD OF THE INVENTION

The present invention relates generally to systems and methods for use in marketing and sales, including in valuation determinations. One embodiment has application in the real estate sector.

### BRIEF DESCRIPTION OF THE DRAWINGS

To facilitate further description of the embodiments, the following drawings are provided. The same reference numerals in different figures denote the same elements.

FIG. 1 illustrates an example of a screen shot of a mobile device displaying one or more methods, according to one or more embodiments.

FIG. 2 illustrates an example of a screen shot of a mobile device displaying one or more methods, according to one or more embodiments.

FIG. 3 illustrates an example of a screen shot of a mobile device displaying one or more methods, according to one or more embodiments.

FIG. 4 illustrates an example of a screen shot of a mobile device displaying one or more methods, according to one or more embodiments.

FIG. 5 illustrates an example of a screen shot of a mobile device displaying one or more methods, according to one or more embodiments.

FIG. 6 illustrates an example of a screen shot of a mobile device displaying one or more methods, according to one or more embodiments.

FIG. 7 illustrates an example of screen shots of a mobile device displaying one or more methods, according to one or more embodiments.

FIG. 8 illustrates an example of screen shot of a mobile device displaying one or more methods, according to one or more embodiments.

FIG. 9 illustrates a block diagram of an example of a system, according to one or more embodiments.

FIG. 10 illustrates a flow chart of an example of a method, according to one or more embodiments.

### DETAILED DESCRIPTION

In some embodiments of the present invention, systems and methods for use in marketing and sales is disclosed. In certain embodiments, the systems and methods include determining a valuation of an item. In the same or other embodiments, the systems and methods are applicable to the real estate sector.

As presented in the description and drawings, the terms “ACE,” “ACE Agent,” or “40 Crickets” are trade names for embodiments of aspects of the present invention.

With respect to the real estate sector, there are many different ways in which the value of a home can be determined. However, known systems and methods in determining the value of homes have their faults.

Embodiments of the present invention comprise systems and methods that utilize “wisdom of the crowd”. “Wisdom of the crowd” is a collective intelligence technique in which opinions from its diverse members, wherein the members are decentralized and have independence from one another, are used to determine an overall opinion. For example, in the real estate industry, agents venture out into the field every day, touring homes and formulating opinions of prices as they do so. The vast experience of these agents can be used to determine an estimated sales price of these houses.

Further embodiments comprise systems and methods that allow individuals to input his or her estimated price at which will a house will sell. With the collective expertise of these individuals (which comprise, for example, real estate agents), collective pricing input, and collective data generated from the inputted data, the information pulled back out of the system would be a huge benefit to all users.

Such embodiments provide real estate agents and/or other individuals with tools that save them and their clients' time and money. Regular use of the systems and methods presented herein will greatly increase the expertise of the agent. The systems and methods also have a community component, which will provide synergistic benefits to all users, as it will take advantage of agents' collective expertise.

According to embodiments, the present invention comprises a method of predicting the sale price of a property. In the same or other embodiments, the present invention comprises a method of predicting the sale price of a house.

According to aspects of this embodiment, this method can comprise the procedures of viewing a house, inserting a predicted selling price of the house, collecting data from multiple users, determining an estimated sales price for a house, and outputting a report. It should be noted that this method can comprise additional procedure not mentioned above. In addition, not every procedure mentioned above needs to be included.

The method of predicting the sale price of a house can comprise a procedure of a user viewing a house. Often a user, such as for example, a real estate agent will view a house during a real estate tour. During such tours, real estate agents will view the new listings of houses for sale in person. Quite often these tours occur on one or two days of the week. Some embodiments of the present invention also include a procedure of organizing a tour of houses for a user to view.

The method of predicting the sale price of a house can comprise a procedure of user inserting his or her predicted sales price of a house. This procedure can be carried out in a number of different ways. As examples, a user can enter his or her predicted sales price of a house. This can be accomplished in many different ways. For example, the user can enter the predicted sales price on a personal computer, via a mobile device, such as, for example, a smart phone, or via a tablet device. In other examples, a user can record his or her predicted sales price to a recording device on a mobile device for entering the predicted price at a later date, such as, for example, via the methods described above. In yet other examples, the user can enter his or her predicted sales price via voice to a mobile device. This voice entry can be transmitted via wireless communications to a central station, whereby it can be entered automatically or another individual can enter the predicted sales price manually. In many embodiments, predicted sales prices from multiple users are collected.

The method of predicting the sale price of a house can comprise a procedure of determining an estimated sales price for a house. According to some embodiments, this procedure of determining an estimated sales price of a house can include using multiple estimates of from professionals in the real estate industry to determine the estimated sales price of a house. In such embodiments, the procedure of determining an estimated sales price for a house comprises using the “wisdom of the crowds.”

In the same or other embodiments, multiple estimated sales prices can be determined. For example, a median, an average, and/or a weighted estimated sales price can be determined. In such an example, the weighted estimated sales price can take into account the prior success of a professional in estimating the price of properties. In such an example, the estimated sales price entered from a user that has a historical track record of making good estimates is given more weight than the estimated sales price from a new user or one that isn't as historically good at making estimates. See the example below for an example of how this procedure of determining an estimated sales price for a house is more accurate than existing procedures.

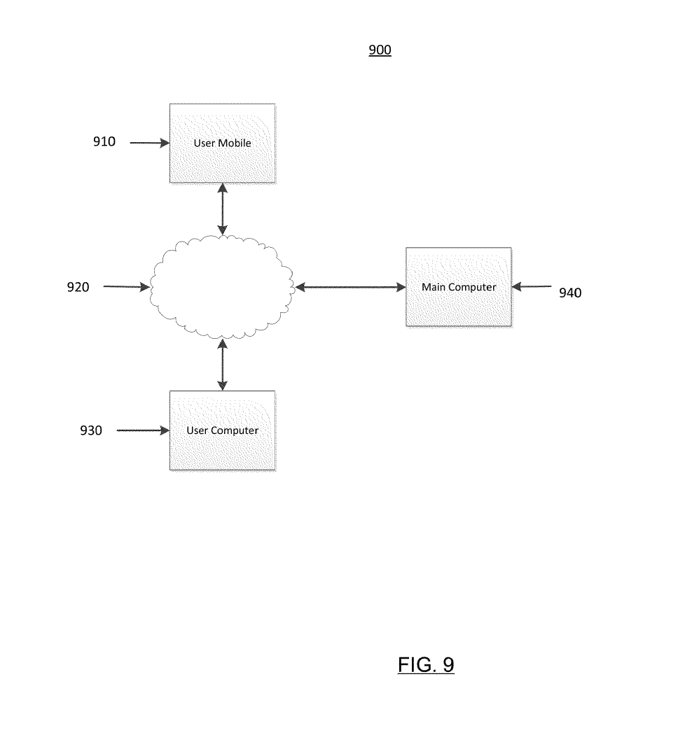

Turning to the drawings, FIG. 9 illustrates an overview of a system 900 for marketing and sales, according to a first embodiment. System 900 is merely exemplary and is not limited to the embodiments presented herein. System 900 can be employed in many different embodiments or examples not specifically depicted or described herein.

In the embodiment of FIG. 9, system 900 comprises at least one computing device, such as, for example, a mobile device 910 and/or a computer 930. Mobile device 910 can be any type of device that can receive data wirelessly from an external source. For example, mobile device 910 can be an Apple iPhone® device, a Blackberry® device, a telephone with an Android™ operating system, a mobile telephone, a PDA (personal digital assistant), an MP3 player, a portable computer, a tablet device, and/or other similar devices. Computer 930 can be any computer that has access to the Internet or similar network connection. Computer 930 can be a laptop and/or a desktop computer. It should be noted that the devices listed as examples for mobile device 910 and/or computer device 930 can include other devices than those specifically mentioned.

Mobile device 910 and computer 930 can be used to receive information pertaining to various properties, such as for example, real estate properties, including houses. In addition, mobile device 910 and computer 930 can be used to input data into the system 900. Such data can include, for example, the user's estimated sales price of a house. It should be noted that many other types of information can be received by the mobile device 910 and computer 930; and many other types of data can be inputted into the system 900 from mobile device 910 and computer 930 than those specifically mentioned here.

Mobile device 910 and computer 903 can be connected to network 920. As an example, network 920 can comprise the Internet and/or a cellular telephone network. In other examples, network 920 can comprise a network specifically created for marketing and sales according to aspects of the present invention.

System 900 can also include main computer 940. Main computer 940 receives the inputs from mobile device 910 and computer 930 via network 920. In addition, main computer 940 is capable of completing calculations that enable an estimated sales price of a property to be calculated. Furthermore, main computer 940 can be capable of handling the various methods discussed herein.

In some examples, main computer 940 can comprise any desktop or laptop computer. In the same or other examples, main computer 940 can comprise one or more databases to store date pertaining to properties, users, etc. The data applicable to users stored in the databases of the computer can be sent to mobile device 910 and/or computer 930 via network 920. In the same or other examples, main computer 940 can comprise a set of computers.

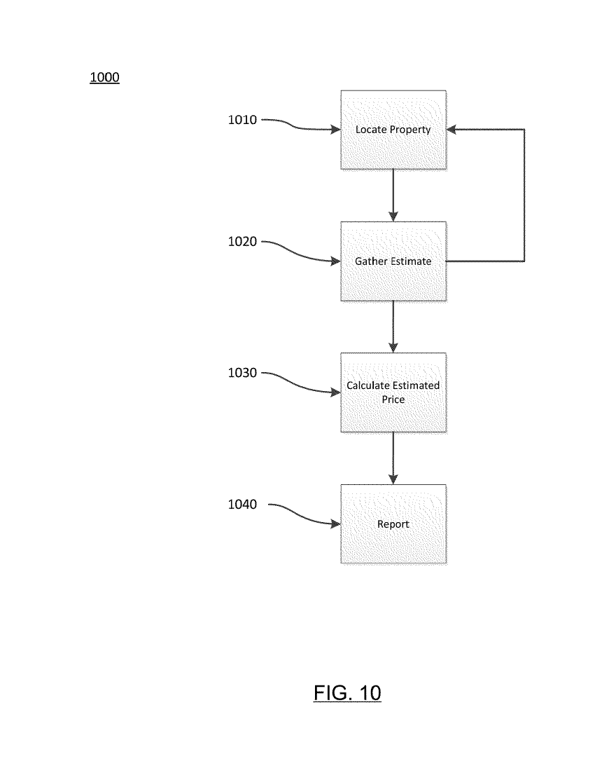

FIG. 10 is a flow chart illustrating an example of a method 1000 of marketing and sales, according to one or more embodiments. Method 1000 can also be considered a method for predicting the sales price of a property. Method 1000 is merely illustrative of a technique for implementing the various aspects of certain embodiments described herein, and method 1000 is not limited to the particular embodiments described herein, as numerous other embodiments are possible. In some embodiments, the various procedures of method 1000 can be performed by a single computer or a set of computers. As an example, the various procedures of method 1000 can be performed by main computer 940 (FIG. 9).

In the example illustrated in FIG. 10, a first procedure of method 1000 is a procedure 1010 of locating a property. In procedure 1010, a property is located in which an estimate is to be produced. The property can be entered into the system via a registered user of the system. The property can be entered into the system via a computer or mobile device. The mobile device can be the same as or similar to mobile device 910 (FIG. 9) and the computer can be the same as or similar to computer 930 (FIG. 9).

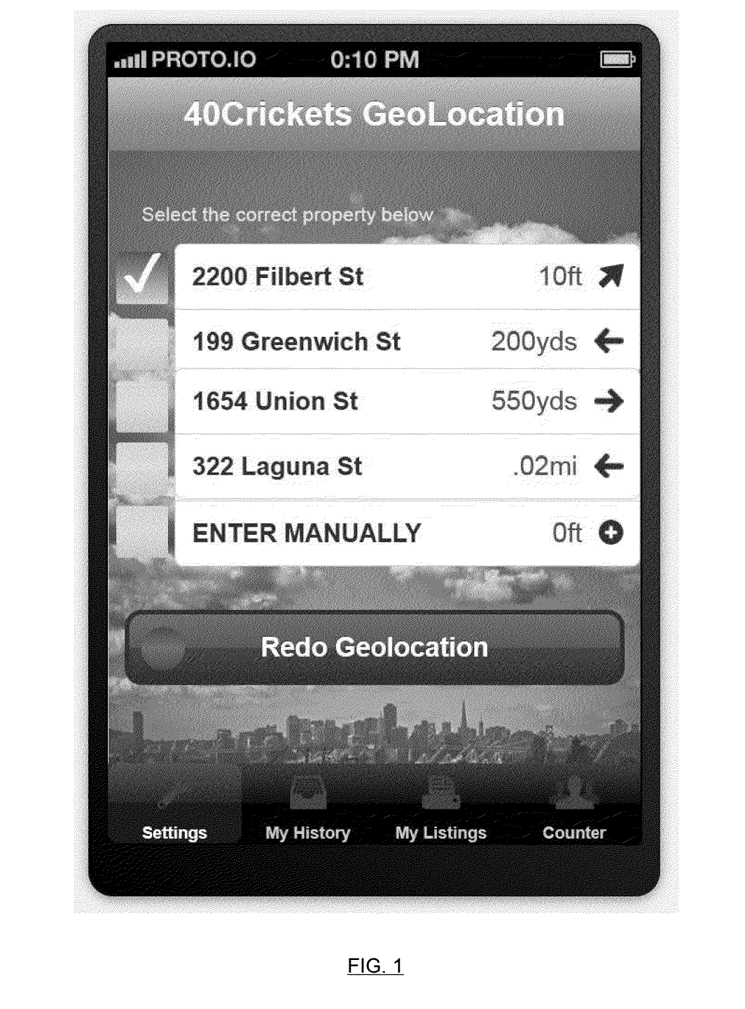

Once a property is registered into the system by a user, third party users can begin to enter their estimates for proper sales price of the property into the system. A third party user can locate a property for which they want to enter an estimated sales price any number of ways. One example is via the use of GeoLocation. FIG. 1 illustrates an example of a screen shot of a mobile device displaying a GeoLocation screen. The mobile device can be the same as or similar to mobile device 910 (FIG. 9).

As an example, and as show in FIG. 1, when using a mobile device that can perform aspects of method 1000, a user can click the button on the home screen labeled “GeoLocate & Submit Price”, and the screen illustrated in FIG. 1 will pop up. The mobile device can turn on its GPS capabilities to GeoLocate the device. Once GeoLocated, the software queries all known real estate listings in the area and sorts them by distance. The user's goal is to submit a pricing opinion on the home at which they are currently located, and this functionality enables them to find it quickly without filling out any forms or typing any information into the system. In some examples there is a ranked list of properties, because GPS signals can sometimes be a little inaccurate. This gives the user the ability to quickly select another option. If the property in question is not on the list, the user may press the “Enter Manually” field to submit the property's info. If the user believes the GPS to be in error, they may also press the “Redo GeoLocation” button to refresh the GPS lock.

Method 1000 can also include a second procedure 1020 of gathering estimates. In procedure 1020, a number of estimates can be entered by any number of users of the system. The more estimates that are entered into the system, the better chance the system has in predicting a better estimated property value. The estimated sales price can be entered in the system from users via a computer or mobile device. The computer can be the same as or similar to computer 930 (FIG. 9). The mobile device can be the same as or similar to mobile device 910 (FIG. 9).

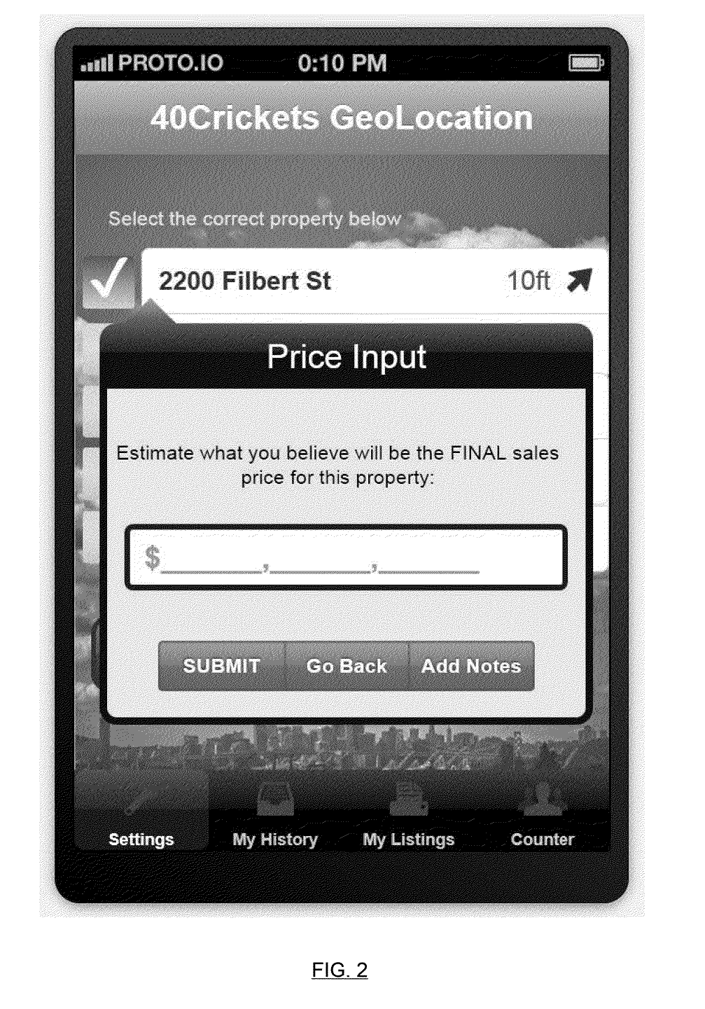

FIG. 2 illustrates an example of a screen shot of a mobile device displaying a screen for entering in an estimated sales price. The mobile device can be the same as or similar to mobile device 910 (FIG. 9). Once the user has verified or manually inputted the property in question, the Price Input window pops up. This window allows the user to input an estimate of what they believe will be the final sales price of the property. They can submit their opinion or append notes. Notes may be in the form of photographs, voice notes, or text. The user may choose to make these notes private or share them with the agent who listed the home.

Next, method 1000 can include a procedure 1030 of calculating an estimated sales price of the property. In some embodiments the sales price is calculated by a main computer. The main computer can be the same as or similar to main computer 940 (FIG. 9).

The estimated sales price of procedure 1030 can comprise a number of different estimates. For example, the estimates can comprise a median estimate price, an average estimated price, and/or a weighted value estimate price.

As an example, there is a property that is listed for sale for $1,000,000. There were 5 opinions gathered on this property. Here are the five opinions:

User 1=$1,035,000

User 2=$1,000,000

User 3=$995,000

User 4=$1,025,000

User 5=$1,010,000

Median=$1,010,000

Average=$1,013,000

However, it is possible to take into account the historical accuracies of each of the users that entered an estimated sales price. From this historical data, the users can be ranked by accuracy from most accurate to least accurate, the five users stack up as such:

User 4=Most accurate. Their vote gets counted 5 times in this example. ($1,025,000×5)

User 3

User 5

User 1

User 2=Least accurate. Their vote only gets counted 1 time in this example. ($1,000,000×1)

Once again, there are five total opinions. In this example the system would count User 4's opinion 5 times, User 3's opinion 4 times, User 5's opinion 3 times, User 1's opinion 2 times and User 2's opinion 1 time. The total value of all the opinions can be added up and then divided by the total number of opinions, which in this case is 15.

The resulting “weighted value” estimate for this property is $1,013,666.

The resulting median estimate for this property is $1,010,000.

The resulting average estimate for this property is $1,013,000.

In this example, the estimates suggest that the property is slightly underpriced.

Next, method 1000 can include a procedure 1040 of producing a report on the estimated sales price of the property. In some embodiments the report is produced by the main computer. The main computer can be the same as or similar to main computer 940 (FIG. 9). In the same or other embodiments, the report can be provided to the mobile device and/or computer to display the report. The computer can be the same as or similar to computer 930 (FIG. 9). The mobile device can be the same as or similar to mobile device 910 (FIG. 9).

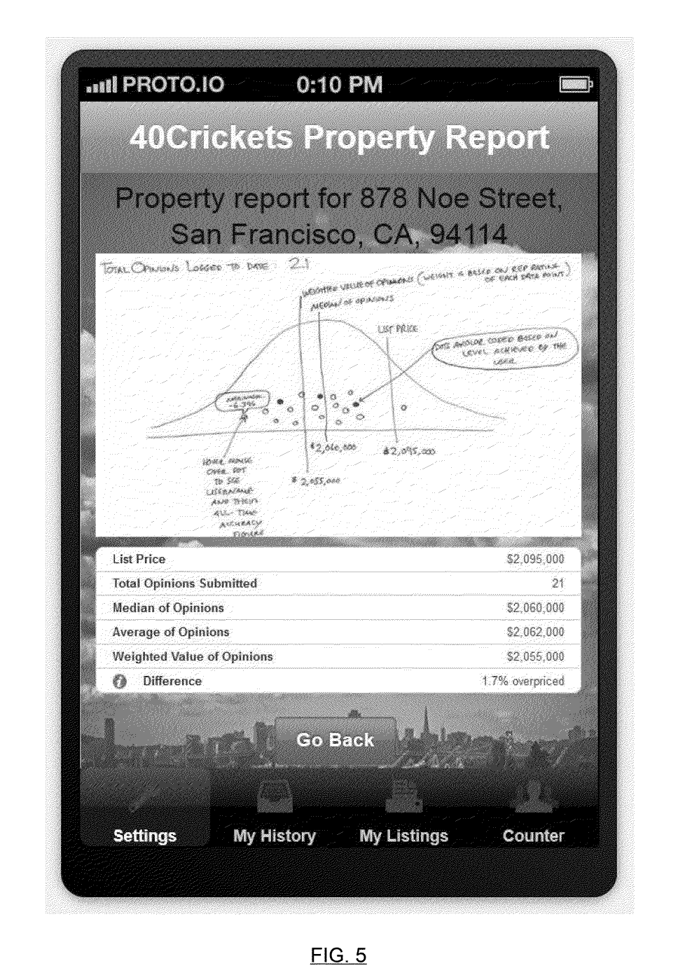

FIG. 5 illustrates an example of a screen shot of a mobile device displaying a screen for displaying a property report. The mobile device can be the same as or similar to mobile device 910 (FIG. 9). There are many types of reports, however, in this example; the user is looking at a bell-curve style distribution of the opinions that were gathered. This information will be extremely valuable for the end user (the real estate agent) and their client. In some embodiments, this information is only viewable by the listing agent. Although, in other embodiments this information may be viewed by agents and their clients.

The bell curve style report featured in the example of FIG. 5 has few lines depicting different types of information.
The list price of the property (this is simply the price at which the property is offered to the market)
The total number of opinions that have been gathered
The median of said opinions
The average of said opinions
The weighted average of said opinions
The difference, which is the difference between the list price of the property and the median value of the gathered opinions. This will indicate whether the crowd believes the property is overpriced, underpriced, or priced correctly.

It should be noted that the property report of procedure 1040 can include other types of information than that depicted in FIG. 5, not include all the information depicted in FIG. 5, or be in a form other than that depicted in FIG. 5.

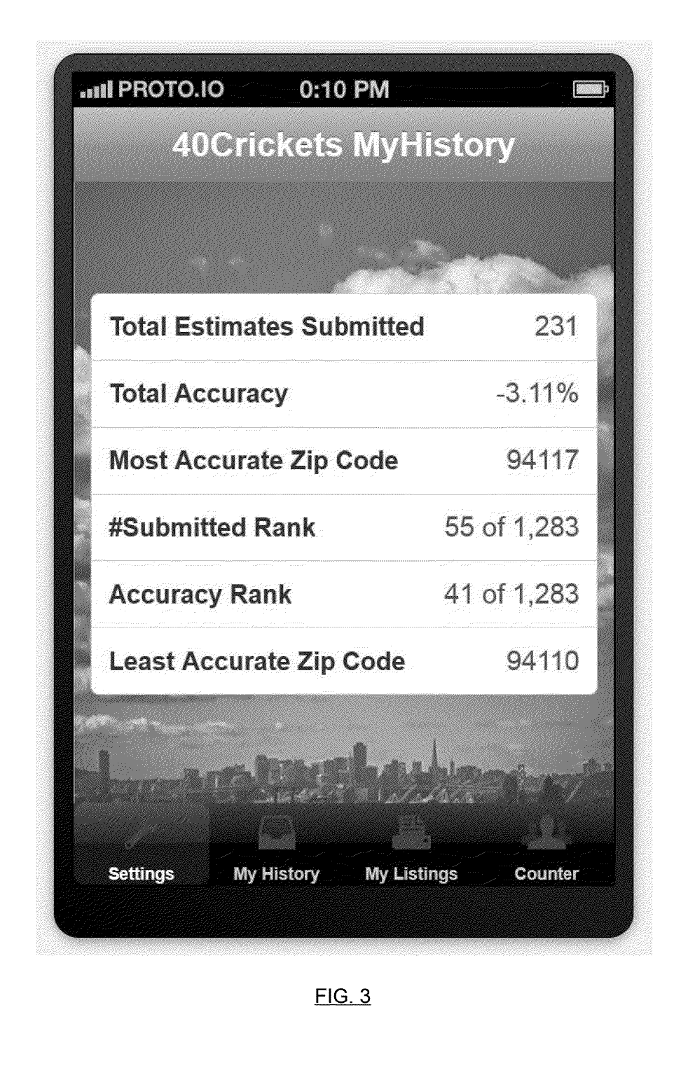

Method 1000 is merely exemplary and may contain more or less procedures than illustrated in FIG. 10. For example, method 1000 can also have a procedure for a user to review the history of his or her estimates of property values. FIG. 3 illustrates an example of a screen shot of a mobile device displaying a screen for a user's history. The mobile device can be the same as or similar to mobile device 910 (FIG. 9).

Over the course of time, a user may have submitted many pricing opinions. The accuracy of said opinions will be determined as each property sells. The original opinion compared to the closing price of each property will determine how accurate the user is. This will be very helpful in aiding the user in learning about his or her tendencies (where they tend to be most accurate in price estimations and where they need the most work.) The rankings section tells the user out of all the users on the system, where they rank in regard to how many overall opinions they have submitted and how accurate they are.

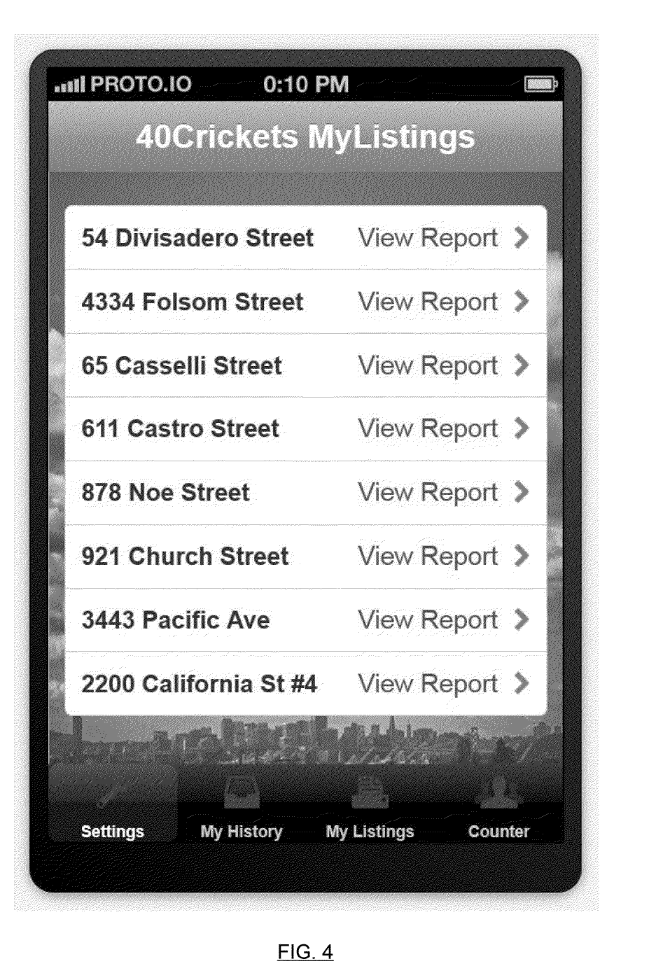

Method 1000 can also have a procedure for a user to review the history of his or her listings. FIG. 4 illustrates an example of a screen shot of a mobile device displaying a screen for a user's history. The mobile device can be the same as or similar to mobile device 910 (FIG. 9). This screen allows a user to look at all the properties he or she has listed in the past and has gathered opinions on. Clicking on each property will dig deeper into the trends that were uncovered for that property.

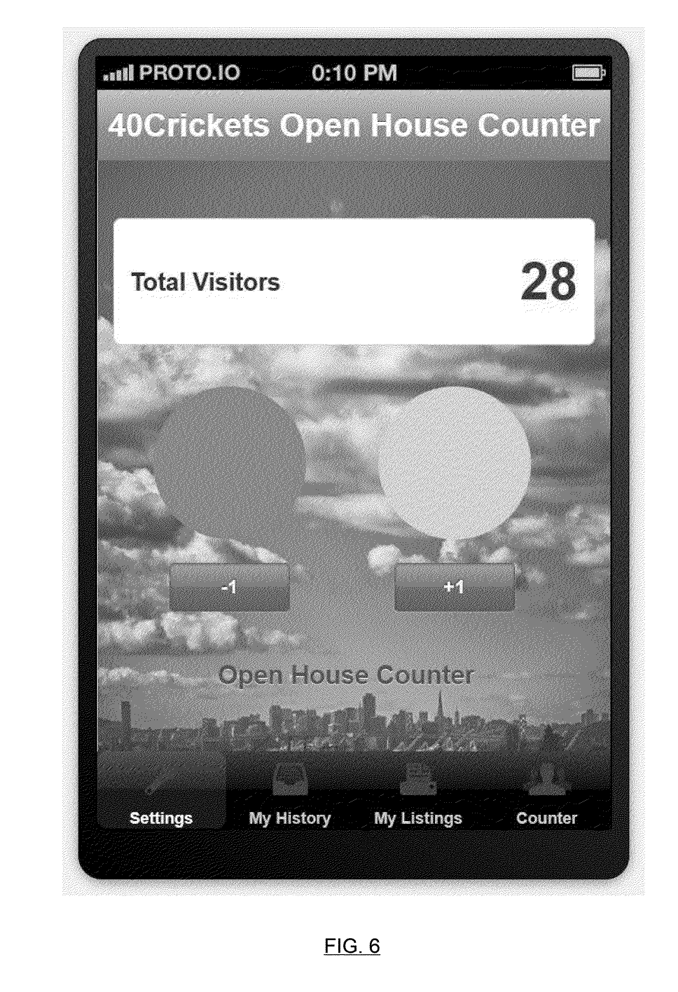

Method 1000 can also have a procedure for a user to keep track of the number of visitors to an open house. FIG. 6 illustrates an example of a screen shot of a mobile device displaying a screen for a user's open house counter. The mobile device can be the same as or similar to mobile device 910 (FIG. 9).

This example of FIG. 6 illustrates an application that allows the user to count heads as they come into an open house or broker's tour. In some embodiments, this information can later be used to create heat maps, showing which properties within a market area garner the most attention in the form of open house traffic.

According to the same or other embodiments, the present invention comprises a method of interactively gathering and presenting information relating to predicting an estimated sales price of a house.

According to aspects of such embodiments, the method can be accomplished via different platforms, such as, for example, on smart phones, on computers, and on tablet devices. As examples, there can be separate apps for smart phones, tablets, and computers. In other examples, web based apps can be created that will function on more than one of these devices. Furthermore, platforms other than those mentioned above can be used in these methods.

Applications according to these methods can contain many different functions. Listed below are examples of a portion of these functions.

Sales

Users of the application will be able to obtain information on all available listings and all available information on sold houses. Information can be obtained using a search function or be geo-location (GPS). Users can access listing and sold details by utilizing search with filtering. Access to images, videos, listing descriptions, and stats can be included.

News

According to embodiments, users of the application can obtain real time market information in his or her news feed. The news feed may comprise, for example, information on industry news, advertisements, or all of the 24-hour market watch activities. The news feed can contain any information that would be relevant to a user of the application.

Market Guide

According to embodiments, users of the application can obtain information on a selected market. Examples of information that will be available can comprise, for example, statistics on available inventory, months supply of inventory, pricing trends, average DOM, and a “health” number. The market guide (or market health) can include any information relative to a particular market.

Real Estate Tour (Tour Now, Tourganizer)

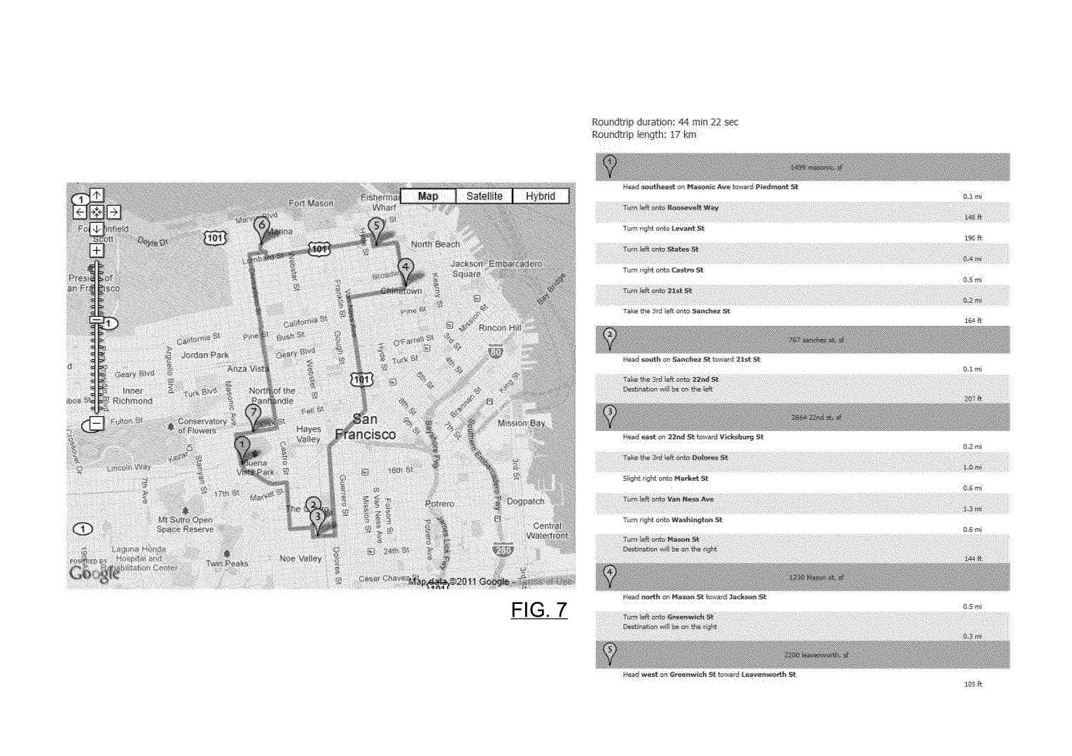

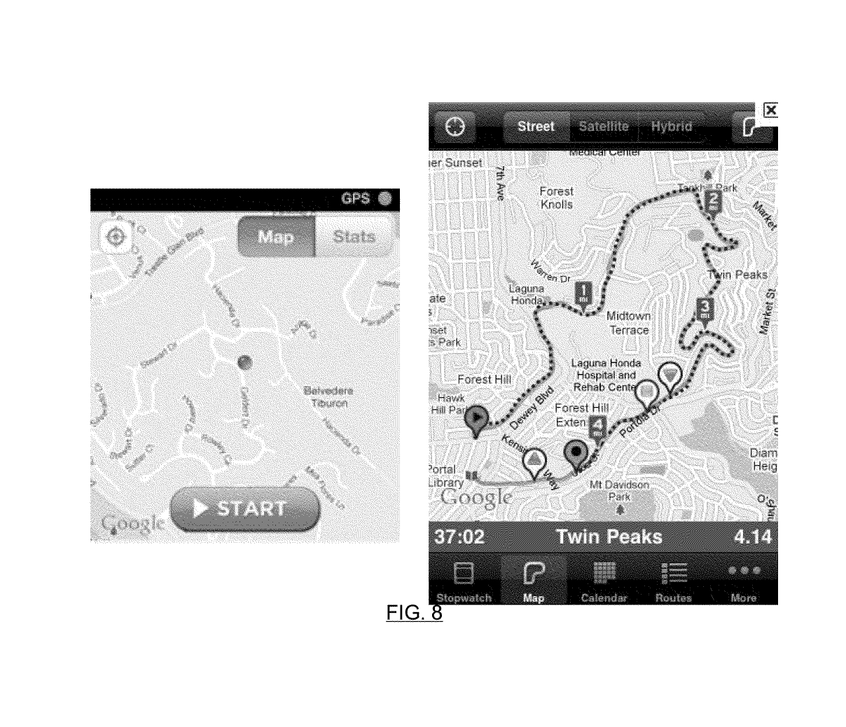

As mentioned above, methods of the present application include a method for organizing a tour of houses. According to embodiments, users of the application have the ability to select properties that they would like to tour (for example, from a Broker's Tour Sheet), and optimize their route. For example, an agent would be able to select each house that she wanted to tour on a given day. The application would be aware of the location of each house and the time at which each hose would be available for viewing. A route would be devised that would assist the agent in finding the best route to each house given the location of each house and the time that each house would be open. FIGS. 7 and 8 illustrate examples of screen shots of a mobile device displaying aspects of a real estate tour. The mobile device can be the same as or similar to mobile device 910.

In some embodiments, the GPS function of a mobile device, tablet, or computer if available would guide the user of the application to each house using a map. Furthermore, the GPS function would be able to detect which house the user was at and provide details of the house, allow the user to make notes, or enter an opinion (estimated sales price) into a central system (see below).

In the same or other embodiments, agents will be able to start, pause, and end a tour. In one example, the agent would push play; the application would assist the agent in arriving at the next house; would recognize when the agent is at the next house; and would provide a reminder to enter a pricing opinion. The application can also be designed to minimize battery usage.

In some examples, the user can press “Play” on his or her mobile device. The user then can stop interacting with the mobile device. For example, the user can put the mobile device in his or her pocket. The user then can proceed to tour properties. Each time the user stops for a predetermined period of time, such, as for example, 5 minutes (it should noted that a period of time greater than or less than 5 minutes can also be used), the system registers that the user is at the nearest listing (property) for sale and the system logs this info. The system is configured to keep a list of all toured properties without any effort or input on part of the user. At the end of the touring, the user can hit “Stop” and the system will generate a report on all the properties at which the user stopped. In some embodiments the system will also display a cookie-crumb trail over a map (such as, for example, a Google® Map) showing the course that the user took, with an icon on each location where the user stopped to tour a home.

Opinion

According to embodiments, users of the application will have the ability to access property details and input a pricing opinion. In some embodiments, the pricing opinion will then be used in a method of determining an estimated sales price of a house (as mentioned above). In addition, the application may be able to maintain an agent's pricing history and comparison against an actual sales price. As mentioned above, there are a number of different ways in which an agent may be able to enter her pricing opinion into the application.

Pricing Tools

According to embodiments, users of the application can access a variety of pricing tools. Non-limiting examples of pricing tools can include: bell curve/distribution on opinions for a specific property (including all of the outputs mentioned above); spread reports showing best and worst deals in a market area; heat maps that show hot and cold areas in the real estate sector; appraiser-style CMA builder; stock ticker info on houses, which can, for example, show a leader board of movers and shakers; create a CAMO; have a counter to indicate the number of times a house has been viewed; show who has been to what house; and who or what is trending. In some examples a heat map is created when the group median for an estimated price is over 10% off on a home. If the group undervalues the property by 10% or more, then it is considered a “hot” home. If the group overvalues the property by 10% or more, then it is considered a “cold” home. It should be noted that values greater than or less than 10% can be used. In addition, other information, such as, for example, the number of visits particular properties or areas get during open houses can also be used to generate heat maps.

Flashcards

According to embodiments, users of the application can create and access flash cards. Flash cards will allow a user to create flash cards for each property that the user is interested in. The flash card can obtain any information that the user desires (such as, for example, a picture, address, number of bedrooms, price, square feet, etc.). The application will then allow the user to flip through the flash cards to study up on all the properties in which she has created a flash card for.

Bin

According to embodiments, users of the application can access their personal history in “My Bin.” Examples of information available through My Bin can include: number of houses toured, opinion accuracy, number of opinions submitted, most toured district, top guesses of all time, best guessed district, etc. It should be recognized that any number of pieces of information can be kept in any user's bin.

Miscellaneous

It should be recognized that any other number of functions can be contained within applications according to embodiments of the present invention. One example is a game. In such an example, users can compete against one another to determine who is better at providing pricing opinions.

In addition, in some embodiments, the application will have universal settings that a user can control. Some examples of settings can include logging in (in some examples a user can log in via LinkedIn, G+, Facebook, Twitter, or any other number of social networks); verifying a DRE number; ability to adjust preferences (such as, for example, menus, favorite neighborhoods, property types, price ranges, when to prompt for an opinion, etc.); etc.

Systems and methods of the present invention can also be applied to areas other than the real estate sector. For example, the following systems and methods may apply to valuations for “items” other than houses.

### EXAMPLE

In a recent San Francisco, Calif. area study, the procedure outlined above was used to determine an estimated sales price houses. Approximately 10 real estate agents were used in the study. In the study 377 homes were profiled and a total of 789 opinions (estimated sales prices) of those homes were gathered. As of this application, 70 of the 377 homes closed escrow. The estimated sales price on those 70 homes achieved a median accuracy of 2.70%. By comparison, Zillow® achieves a median accuracy in California of 10% (8.5% nationwide).

The method of predicting the sale price of a house can comprise a procedure of outputting estimated sales price for a house. Many different values can be extrapolated from the data entered by users of this method. As demonstrated above, a median, an average, and/or a weighted estimated sales price can be determined. In addition, a high, a low, the spread, standard deviation, and a bell curve can also be created using the data entered by the users. This data can then be outputted to the users. In addition, in some embodiments, a confidence rating is supplied that indicates how much confidence a user in the method should place in the determined estimated sales price.

Although the invention has been described with reference to specific embodiments, it will be understood by those skilled in the art that various changes can be made without departing from the spirit or scope of the invention. Accordingly, the disclosure of embodiments is intended to be illustrative of the scope of the invention and is not intended to be limiting. It is intended that the scope of the invention shall be limited only to the extent required by the appended claims. To one of ordinary skill in the art, it will be readily apparent that the semiconductor device and its methods of providing the semiconductor device discussed herein may be implemented in a variety of embodiments, and that the foregoing discussion of certain of these embodiments does not necessarily represent a complete description of all possible embodiments. Rather, the detailed description of the drawings, and the drawings themselves, disclose at least one preferred embodiment, and may disclose alternative embodiments.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A method for determining the estimated sales price of a property comprising:
locating a property;
gathering data representative of multiple estimates for a final sales price of the property; and
transforming the data representative of multiple estimates into a final estimated sales price.

2. The method of claim 1, wherein gathering data representative of multiple estimates for a final sales price of the property comprises gathering data from real estate agents.

3. The method of claim 1, further comprising:
generating a report representative of the final estimated sales price.

4. The method of claim 3, further comprising:
transmitting the report representative of the final estimated sales price to a mobile device.

5. The method of claim 3; further comprising:
transmitting the report representative of the final estimated sales price to a computer.

6. The method of claim 3; where the report representative of the final estimated sales price comprises a bell curve/distribution plot.

7. The method of claim 1; wherein transforming the data representative of multiple estimates into a final estimated sales price comprises using a weighted average.

8. The method of claim 1; wherein transforming the data representative of multiple estimates into a final estimated sales price comprises using an average.

9. The method of claim 1; wherein transforming the data representative of multiple estimates into a final estimated sales price comprises using a median.

10. The method of claim 1; wherein transforming the data representative of multiple estimates into a final estimated sales price comprises using more than one of:
a weighted average;
an average; or
a median.

11. A computer-implemented method of predicting a sales price of a property, comprising:
receiving an estimated final sales price from a plurality of users for a the property;
rating each of the plurality of users according to a value representative of the particular user's historical accuracy of predicting the sale of property; and
transforming the estimated final sales prices from the plurality of users into a final estimated sales price;
wherein the estimated sales price is generated using the ratings of the plurality of users.

12. The method of claim 11, further comprising:
at least one of the plurality of users GeoLocating a property using a mobile device.

13. The method of claim 11, further comprising:
generating a history for at least a portion of the plurality of users; wherein the history comprises at least a portion of previous estimated final sales prices made by the user for other properties.

14. The method of claim 11, further comprising:
generating a listing for at least a portion of the plurality of users; wherein the listing comprises at least a portion of properties the user has listed for sale.

15. The method of claim 11, further comprising:
generating a guided tour for at least one of the plurality of users; wherein the guided tour is representative of one or more properties that at least one of the plurality of users desires to preview.

16. The method of claim 15, wherein:
the guided tour comprises a map showing a location for each of the properties.

17. The method of claim 16, wherein:
the guided tour further comprises a route for the at least one of the plurality of users to take when previewing the properties.

18. The method of claim 11; further comprising:
recording the number of visitors that a property receives during an event.
